(19) United States
(12) Patent Application Publication
(10) Pub. No.: US 2011/0173543 A1
(43) Pub. Date: Jul. 14, 2011

(54) SYSTEM AND METHOD TO ASSIST CUSTOMERS IN SELECTING COMPATIBLE COMPONENTS OF A PRODUCT

(76) Inventors: Oliver N. Cockcroft, Los Gatos, CA (US); Eric J. Farraro, San Jose, CA (US); Richard Hoiberg, Gilroy, CA (US); John Tapley, Santa Clara, CA (US)

(21) Appl. No.: 12/685,441

(22) Filed: Jan. 11, 2010

(51) Int. Cl. G06F 3/048; G06F 15/16; G06F 17/30

(52) U.S. Cl. 715/738; 707/758; 707/E17.014

(57) ABSTRACT

Systems and methods to assist buyers in selecting compatible components of a product are described. The system identifies a product associated with a plurality of component classes. Next, the system identifies a list of items by searching for items based on the component classes. The system then receives a selection of a first item. After a selection of the first item has been received, the system generates a list of compatible items by removing items from the identified list of items that are incompatible with the first item. Finally, the system presents the buyer with a user interface communicating the list of compatible items.

### TECHNICAL FIELD

This disclosure relates to the technical field of data communications and, more particularly, to system and method to assist a customer in selecting compatible components of a product.

### RELATED ART

A buyer may wish to acquire products that are made up of multiple items. The buyer may find that purchasing such products is burdensome because he or she is tasked with identifying the types of items required for the product and whether the items selected, in accordance with the identified types, are compatible to create a complete and working product.

### BRIEF DESCRIPTION OF THE DRAWINGS

Embodiments illustrated by way of example and not limitation in the figures of the accompanying drawings, in which:

FIG. 1 illustrates a system, according to an embodiment, to assist customers in selecting compatible components of a product;

FIG. 2 further illustrates the system, according to an embodiment, to assist customers in selecting compatible components of a product;

FIG. 3 is a block diagram illustrating a system, according to an embodiment, to execute the methods described herein;

FIG. 4 is a block diagram illustrating marketplace modules and payment modules, according to an embodiment;

FIG. 5 is a block diagram illustrating tables, according to an embodiment;

FIG. 6A is a block diagram illustrating a product table according to an embodiment;

FIG. 6B is a block diagram illustrating an item table according to an embodiment;

FIG. 6C is a block diagram illustrating item information, according to an embodiment;

FIG. 7 is flowchart illustrating a method to assist customers in selecting compatible components of a product, according to an embodiment;

FIG. 8 is a flowchart illustrating a method to identify a product, according to an embodiment;

FIG. 9 is a flowchart illustrating a method to identify items associated with component classes of a product, according to an embodiment;

FIG. 10 is a flowchart illustrating a method to determine item compatibility, according to an embodiment;

FIG. 11 is a diagram illustrating a user interface according to an embodiment; and

FIG. 12 illustrates a diagrammatic representation of a machine in the example form of a computer system, according to an embodiment.

### DETAILED DESCRIPTION

Some products, such as computer systems, home theatre systems, or home entertainment systems, may be described with component classes. For example, home computer systems are typically described with component classes including a monitor, keyboard, mouse, case, motherboard, storage devices (e.g., hard disk drive, CD-ROM drive, etc.), and RAM. Items associated with these component classes may not be compatible with each other. For example, a particular motherboard may be compatible with a USB mouse but not an older serial mouse. Thus, a buyer wishing to purchase the product may be burdened with identifying the component classes that make up the product, finding items associated with those component classes, and ensuring that the found items are compatible with each other. These burdens may unnecessarily impeded sales.

Some vendors that sell items associated with the component classes of a product may use item compatibility lists to pre-map compatible items. Some of these compatibility lists may be manually generated based on the vendors' current item offerings. Some of these compatibility lists may be purchased or provided by an outside party. Using such lists may present problems. For example, a rapidly changing inventory may cause the lists to become obsolete.

Buyers may be assisted in the purchase of products by guiding them through the constituent component classes of the product and presenting items associated with each of those component classes. Using item attributes to automatically identify items associated with the component classes of a product and to dynamically eliminate incompatible items may reduce customer burdens in purchasing the product and thus increase sales.

In the following description, for purposes of explanation, numerous specific details are set forth in order to provide a thorough understanding of some example embodiments. It will be evident, however, to one of ordinary skill in the art that embodiments of the present disclosure may be practiced without these specific details.

As described further below, according to various example embodiments of the disclosed subject matter described and claimed herein, a system and method to assist a customer in selecting compatible components of a product are described. Various embodiments are described below in connection with the figures provided herein.

The example embodiments described herein seek to assist buyers who purchase items that may be associated with component classes of a product. As used here, product and products refer to an application made up of constituent component classes. For example, an application in the form of a home computer system may be composed of component classes in the forms of a monitor, a case, a processor, a motherboard, RAM, storage devices (e.g., hard disk drives), input devices, etc. Items may be parts of a product associated with one or more of the product's component classes. While many of the example embodiments are discussed in the context of determining whether items associated with the component classes of a desktop computer are compatible to constitute a complete desktop computer system, it will be appreciated that the system and method described herein may be applied to a broad range of item compatibility use scenarios (e.g., parts for theatre systems, entertainment system, or any other product having a plurality of component classes). Further, it will be appreciated that the methods and systems described herein may be applied to a broad range of technical problems some of which are described as follows.

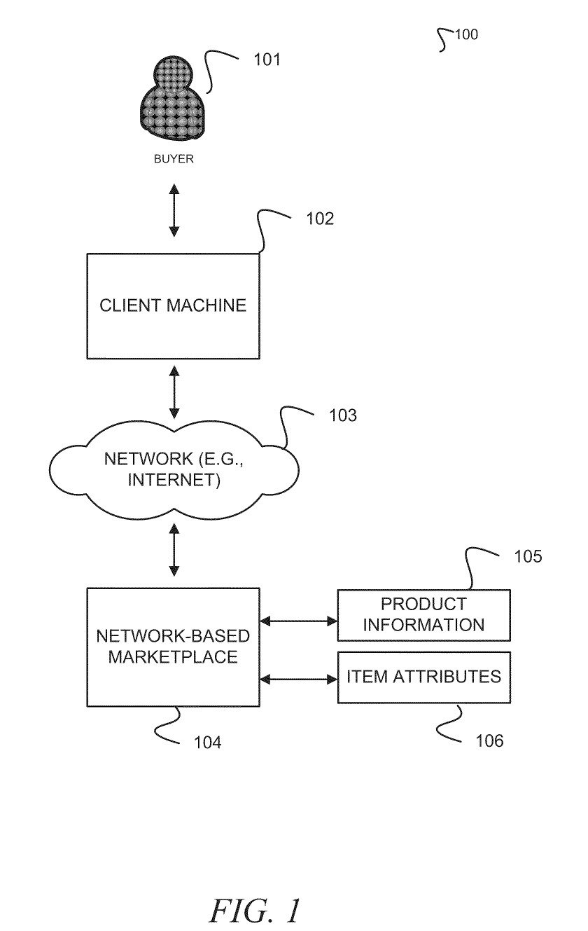

FIG. 1 is a network diagram depicting a networked system 100, within which one example embodiment may be deployed. The networked system 100 is shown to include a buyer 101 who uses a client machine 102 (e.g., a home computer or a mobile phone) that, in turn, communicates with a network-based marketplace 104 over a network 103 (e.g., the internet). Product information 105 and item attributes 106 may be accessed by the network-based marketplace 104. In various embodiments, the product information 105 or the item attributes 106 may be stored within the network-based marketplace 104.

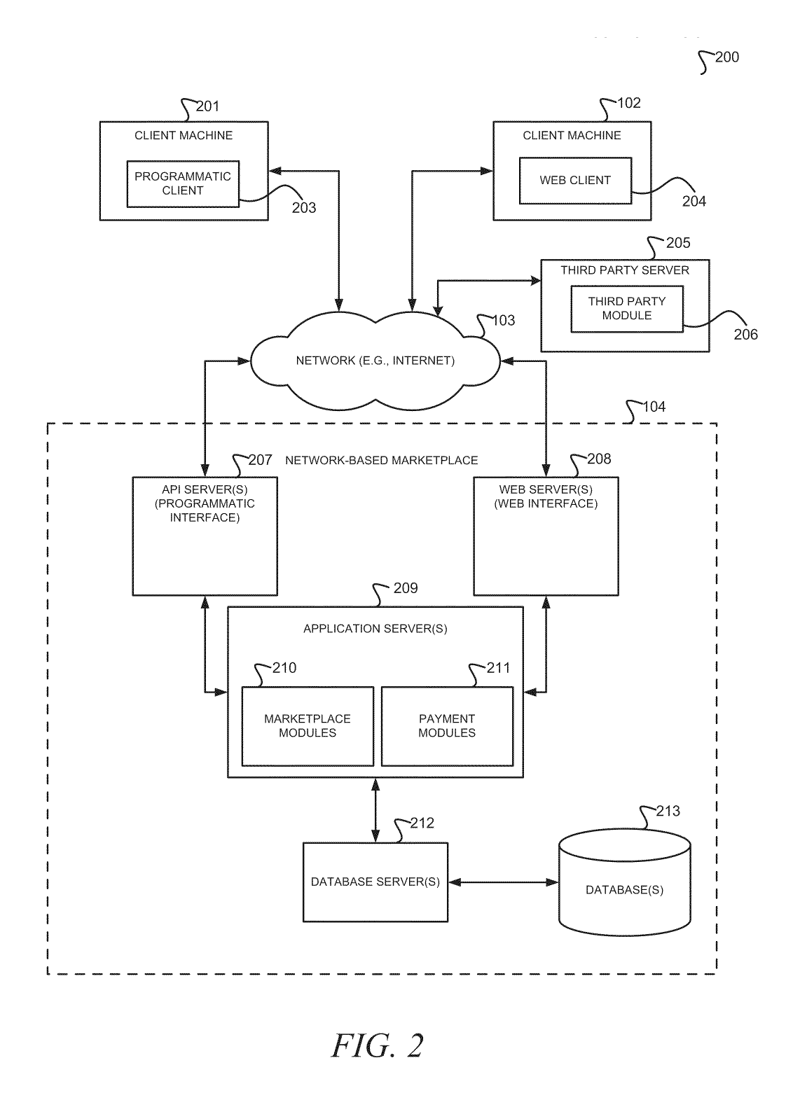

FIG. 2 is network diagram depicting a networked system 200, within which one example embodiment may be deployed. The networked system 200 corresponds to the networked system 100 in FIG. 1 and, accordingly, the same or similar references have been used to indicate the same or similar features unless otherwise indicated. A network-based marketplace 104 provides server-side functionality, via a network 103 (e.g., the internet or Wide Area Network (WAN)) to one or more clients. FIG. 2 illustrates, for example, a web client 204 (e.g., a browser, such as the Internet Explorer browser developed by Microsoft Corporation of Redmond, Wash. State) executing on client machine 102, and a programmatic client 203 executing on client machine 201.

An Application Program Interface (API) server 207 and a web server 208 are coupled to, and provide programmatic and web interfaces respectively to, one or more application servers 209. The application servers 209 host one or more marketplace modules 210 and payment modules 211. The application servers 209 are, in turn, shown to be coupled to one or more database servers 212 that facilitate access to one or more databases 213.

The marketplace modules 210 may provide a number of marketplace functions and services to users that access the network-based marketplace 104. The payment modules 211 may likewise provide a number of payment services and functions to users. The payment modules 211 may allow users to accumulate value in accounts and then later redeem the accumulated value for items (e.g., goods or services) that are made available via the marketplace modules 210. The value may be accumulated in a commercial currency, such as the U.S. dollar, or a proprietary currency, such as “points.” While both form part of the network-based marketplace 104, it will be appreciated that, in alternative embodiments, the payment modules 211 may form part of a payment service that is separate and distinct from the network-based marketplace 104.

Further, while the networked system 200 shown in FIG. 2 employs a client-server architecture, embodiments of the present disclosure are of course not limited to such an architecture and could equally well find application in a distributed, or peer-to-peer, architecture system, for example. The various marketplace modules 210 and payment modules 211 could also be implemented as standalone software programs, which do not necessarily have networking capabilities.

The web client 204 accesses the various marketplace modules 210 and payment modules 211 via a web interface supported by the web server 208. Similarly, the programmatic client 203 accesses the various services and functions provided by the marketplace modules 210 and payment modules 211 via the programmatic interface provided by the API server 207. The programmatic client 203 may, for example, be a seller application (e.g., the TurboLister application developed by eBay Inc., of San Jose, Calif.) to enable sellers to author and manage listings on the network-based marketplace 104 in an offline manner, and to perform batch-mode communications between the programmatic client 203 and the network-based marketplace 104.

FIG. 2 also illustrates a third party module 206, executing on a third party server 205, as having programmatic access to the networked system 200 via the programmatic interface provided by the API server 207. For example, the third party module 206 may, utilizing information retrieved from the network-based marketplace 104, support one or more features or functions on a website hosted by the third party. The third party website may, for example, provide one or more promotional, marketplace or payment functions that are supported by the relevant applications of the networked system 200.

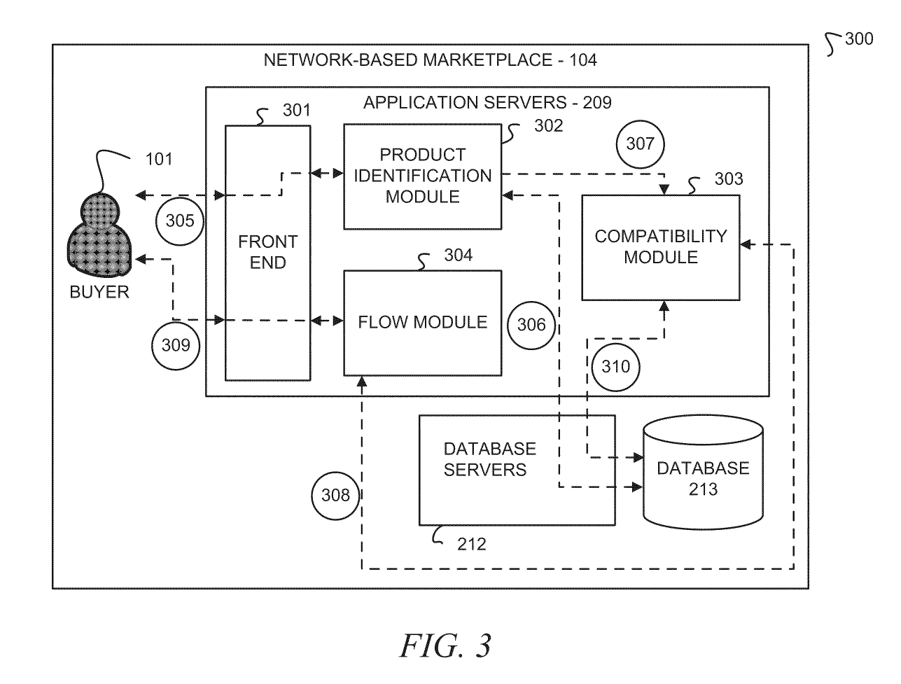

FIG. 3 is a block diagram illustrating a system 300, according to an embodiment, to execute the methods described herein. The system 300 corresponds to the networked systems 100 and 200 in FIG. 1 and FIG. 2. Accordingly, the same or similar references have been used to indicate the same or similar features unless otherwise indicated. The networked system 200 is shown to include a network-based marketplace 104 including application servers 209 and database servers 212. The application servers 209 may support a front end 301, a product identification module 302, a compatibility module 303, and a flow module 304.

The front end 301 may be used to communicate with the buyer 101. The front end 301 may include other components of the network-based marketplace 104 to search for items on the network-based marketplace 104 for subsequent purchase or auction, to identify products, and to communicate a user interface to assist the buyer 101 in the purchase of items associated with one or more component classes of a product. For example, the front end 301 may receive an item selection from the buyer 101 and communicate with a product identification module 302 to receive one or more products that has a component class with which the item may be associated. The front end 301 may also present the buyer 101 with a list of products to choose from, or allow the buyer 101 to search for a product, via a connection (not shown) to the one or more databases 213 through the database servers 212. The product identification module 302 may communicate with the one or more databases 213 through the database servers 212 to identify products that include component classes with which a buyer 101 selected item may be associated. The product identification module 302 may also communicate with the compatibility module 303 to pass the product component classes and the items already selected by the buyer 101. The compatibility module 303 may communicate with the one or more databases 213 to identify items associated with each component class of a buyer 101 selected product. The compatibility module 303 may remove identified items that are incompatible with items already selected by the buyer 101. The compatibility module 303 may communicate the product component classes, and associated items, to the flow module 304. The flow module 304 may communicate with the front end 301 to assist the buyer 101 in selecting items associated with the component classes of the product. The flow module 304 communicates with the compatibility module 303 to dynamically remove items presented to the buyer 101 that are incompatible with buyer 101 selected items, as the buyer 101 selects each new item.

Broadly speaking the system 300 may be described to operate as follows. At operation 305 the buyer 101 communicates a desire to purchase a product. For example, the buyer 101 may select a product from a list of products, the list being presented in response to a user search or in response to the buyer 101 selecting an item from the network-based marketplace 104 that corresponds to one or more products. At operation 306, the product identification module 302 identifies the component classes of the product. At operation 307, the product identification module 302 passes the component classes to the compatibility module 303, along with a list of one or more buyer 101 selected items. At operation 310 the compatibility module searches the one or more databases 213 to identify items associated with the component classes. The compatibility module 303 removes identified items that are incompatible with the one or more buyer 101 selected items. According to one embodiment, the removal of an identified item may be performed, for example, by analyzing the item attributes 106 associated with the item. For example, if the buyer 101 selected a motherboard with a “775 processor socket,” then processors that were identified by the buyer 101 that did not fit into a “775 processor socket,” would be removed. At operation 308, the compatibility module 303 communicates the component classes and item information to the flow module 304. At operation 308, the flow module 304 communicates subsequent buyer 101 selected items to the compatibility module 303 that dynamically performs additional item compatibility operations. In one embodiment, the selected items may be communicated responsive to receiving the respective selections. At operation 309 the flow module 304 interactively presents the component classes and associated items to the buyer 101 enabling the buyer to select items to complete the product.

### Marketplace and Payment Modules

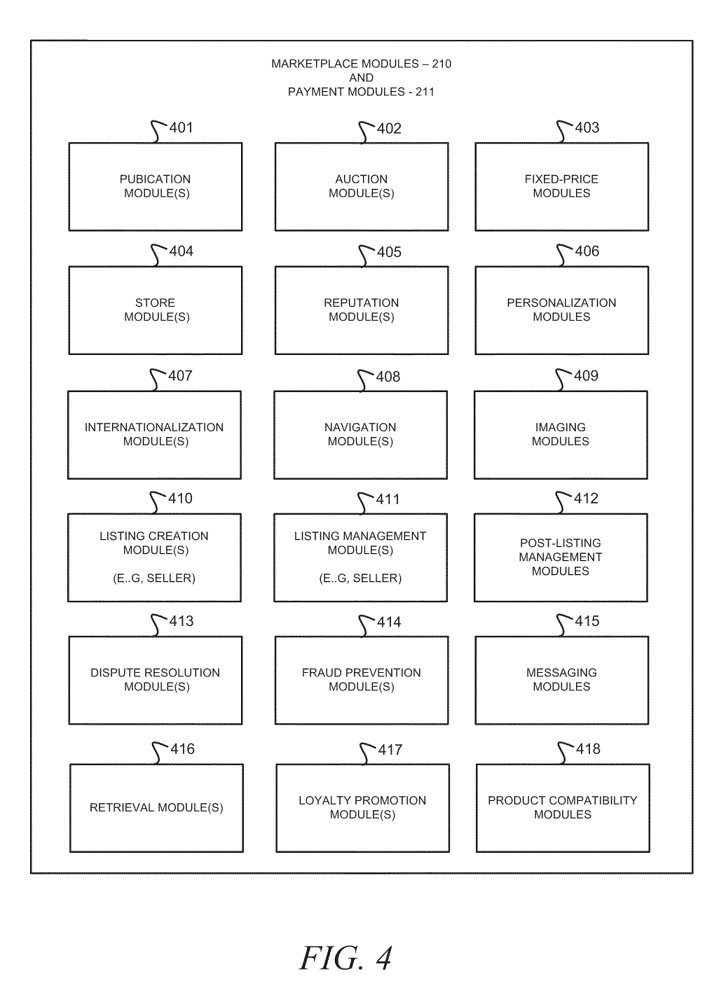

FIG. 4 is a block diagram illustrating marketplace modules 210 and payment modules 211 that, in one example embodiment, are provided as part of the networked system 200 as shown on FIG. 2. The marketplace modules 210 and payment modules 211 may be hosted on dedicated or shared server machines, as shown on FIG. 2, that are communicatively coupled to enable communications between sever machines. The modules themselves are communicatively coupled (e.g., via appropriate interfaces) to each other and to various data sources, so as to allow information to be passed between the modules or so as to allow the modules to share and access common data. The modules may furthermore access one or more databases 213 via the database servers 212, as shown on FIG. 2.

The network-based marketplace 104 may provide a number of publishing, listing, and price-setting mechanisms whereby a seller may list (or publish information concerning) goods or services for sale; a buyer may express interest in or indicate a desire to purchase such goods or services; and a price may be set for a transaction pertaining to the goods or services. To this end, the marketplace modules 210 are shown to include at least one publication module 401 and one or more auction modules 402, which support auction-format listing and price setting mechanisms (e.g., English, Dutch, Vickrey, Chinese, Double, Reverse auctions, etc.). The various auction modules 402 may also provide a number of features in support of such action-format listings, such as a reserve price feature whereby a bidder may invoke automated proxy bidding.

A number of fixed-price modules 403 may support fixed-price listing formats (e.g., the traditional classified advertisement-type listing or a catalogue listing) and buyout-type listings. Specifically, buyout-type listings (e.g., including the Buy-It-Now (BIN) technology developed by eBay Inc., of San Jose, Calif.) may be offered in conjunction with auction-format listings and may allow a buyer to purchase goods or services, which are also being offered for sale via an auction, for a fixed-price that is typically higher than the starting price of the auction.

Store modules(s) 404 may allow a seller to group listings within a “virtual” store, which may be branded and otherwise personalized by and for the seller. Such a virtual store may also offer promotions, incentives and features that are specific and personalized to a relevant seller.

Reputation module(s) 405 may allow users that transact, utilizing the network-based marketplace 104, to establish, build and maintain reputations, which may be made available and published to potential trading partners. Consider, for example, that where the network-based marketplace 104 supports person-to-person trading, users may otherwise have no history or other reference information whereby the trustworthiness and credibility of potential trading partners may be assessed. The reputation module(s) 405 allow a user to establish a reputation within the network-based marketplace 104 over time, for example, through feedback provided by other transaction partners. Other potential trading partners may then reference such a reputation for the purposes of assessing credibility and trustworthiness.

Personalization modules 406 may allow users of the network-based marketplace 104 to personalize various aspects of their interactions with the network-based marketplace 104. For example a user may, utilizing appropriate personalization modules 406, create a personalized reference page at which information regarding transactions to which the user is (or has been) a party may be viewed. Further, the personalization modules 406 may enable a user to personalize listings and other aspects of their interactions with the networked system 200 and other parties.

The networked system 200 may support a number of marketplaces that are customized, for example, for specific geographic regions. A version of the networked system 200 may be customized for the United Kingdom, whereas another version of the networked system 200 may be customized for the United States. Some of these versions may operate as an independent marketplace, or may be customized (or internationalized) presentations of a common underlying marketplace. The networked system 200 may accordingly include a number of internationalization modules 407 that customize information (and/or the presentation of information) by the networked system 200 according to predetermined criteria (e.g., geographic, demographic or marketplace criteria). For example, the internationalization modules 407 may be used to support the customization of information for a number of regional websites that are operated by the networked system 200.

Navigation of the network-based marketplace 104 may be facilitated by one or more navigation modules 408. For example, browse modules may allow users to browse various category, catalogue, or inventory data structures according to which listings may be classified within the networked system 200. Various other navigation modules 408 may be provided to supplement the search and browsing modules.

In order to make listings available via the networked system 200 as visually informing and attractive as possible, the marketplace and payment modules 210 and 211 may include one or more imaging modules 409 with which users may upload images for inclusion within listings. The imaging modules 409 may also operate to incorporate images within viewed listings. The imaging modules 409 may also support one or more promotional features, such as image galleries that are presented to potential buyers. For example, sellers may pay an additional fee to have an image included within a gallery of images for promoted items.

Listing creation modules 410 may allow sellers to conveniently author listings of items (e.g., parts) pertaining to goods or services that they wish to transact via the network-based marketplace 104. The listing management modules 411 may allow sellers to manage such listings. Specifically, where a particular seller has authored and/or published a large number of listings, the management of such listings may present a challenge. The listing management modules 411 may provide a number of features (e.g., auto-relisting, inventory level monitors, etc.) to assist the seller in managing such listings.

One or more post-listing management modules 412 may also assist sellers with a number of activities that may typically occur post-listing. For example, upon completion of an auction facilitated by one or more auction module(s) 402, a seller may wish to leave feedback regarding a particular buyer. To this end, the post-listing management modules 412 may provide an interface to one or more reputation module(s) 405, so as to allow the seller conveniently to provide feedback regarding multiple buyers to the reputation module(s) 405.

Dispute resolution modules 413 may provide mechanisms whereby disputes arising between transacting parties may be resolved. For example, the dispute resolution modules 413 may provide guided procedures whereby the parties are guided through a number of steps in an attempt to settle a dispute. In the event that the dispute may not be settled via the guided procedures, the dispute may be escalated to a third party mediator or arbitrator.

A number of fraud prevention modules 414 may implement fraud detection and prevention mechanisms to reduce the occurrence of fraud within the network-based marketplace 104.

Messaging modules 415 may be responsible for the generation and delivery of messages to users of the network-based marketplace 104, with such messages, for example, advising users regarding the status of listings at the network-based marketplace 104 (e.g., providing “outbid” notices to bidders during an auction process or providing promotional and merchandising information to users). Respective messaging modules 415 may utilize any one of a number of message delivery networks and platforms to deliver messages to users. For example, messaging modules 415 may deliver electronic mail (e-mail), instant message (IM), Short Message Service (SMS), text, facsimile, or voice (e.g., Voice over IP (VoIP)) messages via the wired network (e.g., the Internet), Plain Old Telephone Service (POTS), or wireless (e.g., mobile, cellular, WiFi (e.g., IEEE 802.11 technologies including 802.11n, 802.11b, 802.11g, and 802.11a)), Worldwide Interoperability for Microwave Access (e.g., WiMAX-IEEE 802.16) networks.

Retrieval modules 416 may support various searching functions that are made available to buyers to enable buyers to find listings. The retrieval modules 416 may for example include a finding module and a search module. The finding module may enable a buyer to enter queries that may be parsed to identify item information describing a sought after item. The finding module may further communicate the item information as a constructed query to the search module to cause the search module to search the one or more databases 213 to identify appropriate listings.

The network-based marketplace 104 itself, or one or more parties that transact via the network-based marketplace 104, may operate loyalty programs that are supported by one or more loyalty promotions modules 417. For example, a buyer may earn loyalty or promotions points for transactions established and/or concluded with a particular seller, and then be offered a reward for which accumulated loyalty points can be redeemed.

Product compatibility modules 418 may support various compatibility functions and services on products and items. The product compatibility modules 418 may for example include the previously mentioned product identification module 302, compatibility module 303, and flow module 304, as shown on FIG. 3. The product identification module 302 may enable a buyer 101 to select a product that may be used to identify items that may be purchased to complete the product. The product identification module 302 may further identify products having component classes with which a previously selected buyer 101 item may be associated. The compatibility module 303 may identify items associated with a product's component classes and ensure the items are compatible with items already selected by the buyer 101. For example, item attributes 106 for the identified items and the items already selected by the buyer 101 may be analyzed by the compatibility module 303 for compatibility, e.g., that a motherboard supports the socket of a processor selected by the buyer 101. The flow module 304 may assist the buyer 101 in selecting items associated with each component class of a product. For example, the flow module 304 may present the buyer 101 with a user interface which provides a checklist of the component classes and allows the buyer to select a component class and then display the items associated with that component class. The flow module 304 may advance the buyer 101 through the component classes, thus guiding the buyer 101 through the purchase of the complete product. The flow module 304 may communicate with the compatibility module 303 after each buyer 101 selection of an item to remove items that are no longer compatible with the already selected items.

### Data Structures

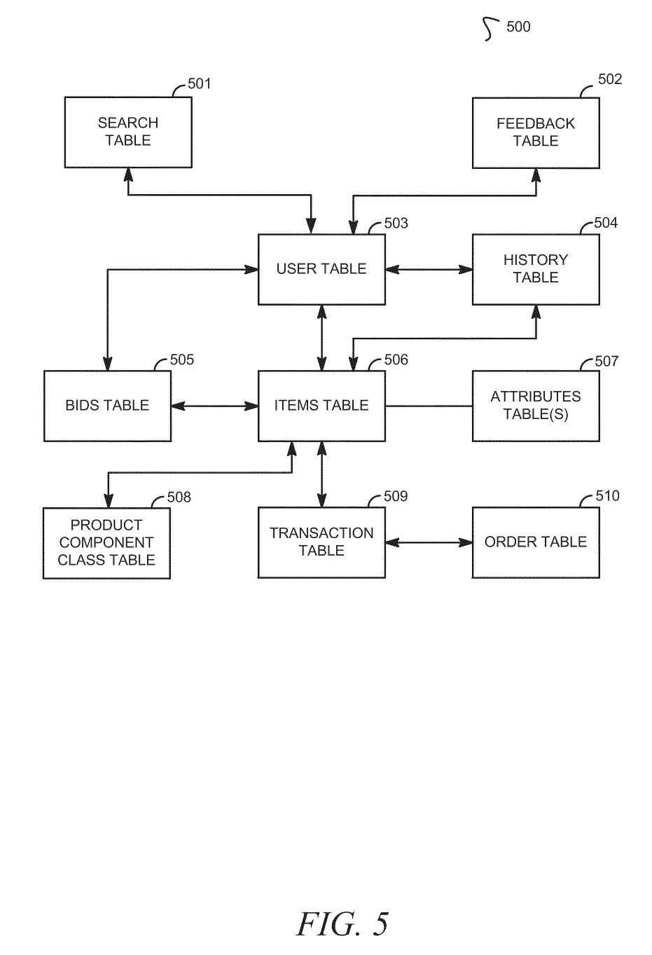

FIG. 5 is a high-level entity-relationship diagram illustrating various tables 500 that may be maintained within the one or more databases 213, and that are utilized by and support the marketplace modules 210 and payment modules 211, as shown on FIG. 2. A user table 503 contains a record for registered users of the network-based marketplace 104. A user may operate as a seller, a buyer, or both, within the network-based marketplace 104. In one example embodiment, a buyer may be a user that has accumulated value (e.g., commercial or proprietary currency), and is accordingly able to exchange the accumulated value for items that are offered for sale by the network-based marketplace 104.

The tables 500 also include an items table 506 in which item records are maintained for goods and services that are available to be, or have been, transacted via the network-based marketplace 104. Item records within the items table 506 may furthermore be linked to one or more user records within the user table 503, so as to associate a seller and one or more actual or potential buyers with an item record.

A transaction table 509 contains a record for each transaction (e.g., a purchase or sale transaction) pertaining to items for which records exist within the items table 506.

An order table 510 may be populated with order records, with each order record being associated with an order. Each order, in turn, may be associated with one or more transactions for which records exist within the transaction table 509.

Bid records within a bids table 505 may relate to a bid received at the network-based marketplace 104 in connection with an auction-format listing supported by one or more auction modules 402, as shown in FIG. 4. A feedback table 502 may be utilized by one or more reputation modules 405, in one example embodiment, to construct and maintain reputation information concerning users. A history table 504 may be used to maintain a history of transactions to which a user has been a party. One or more attributes tables 507 record attribute information pertaining to items for which records exist within the items table 506. Considering only a single example of such an attribute, the attributes tables 507 may indicate a currency attribute associated with a particular item, with the currency attribute identifying the currency of a price for the relevant item as specified by a seller. A search table 501 may store search information that has been entered by a user (e.g., buyer) who is looking for a specific type of listing.

A product component class table 508 contains records of products and their constituent component classes. The product component class table 508 may further contain references to the items table 506. The product component class table 508 may be used by the product identification module 302 as shown on FIG. 3.

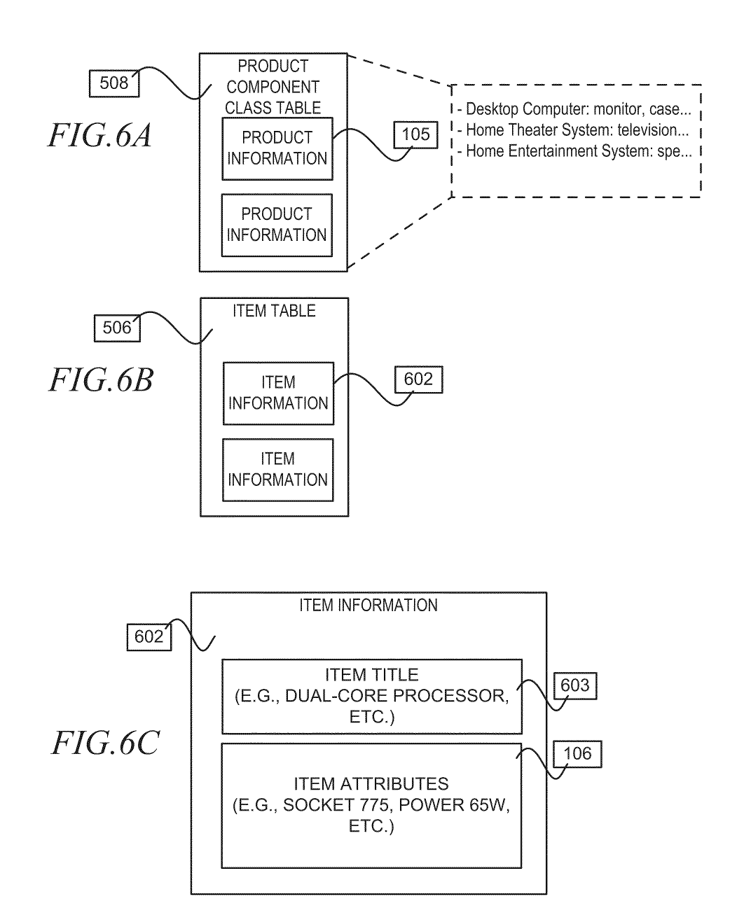

FIG. 6A is a block diagram illustrating a product component class table 508, according to an embodiment. The product component class table 508 includes multiple entries or records that may store product information 105. For example, the product component class table 508 may store a record for a desktop computer, a home theatre system, and a home entertainment system. Further, for example, the entry for the home entertainment system may include product information 105 including the component classes of the home entertainment system, such as speakers and a receiver. In various embodiments, product subdivisions may exist as different products, such as a high definition home theatre system and a standard home theatre system each being distinct products.

FIG. 6B is a block diagram illustrating an items table 506, according to an embodiment. The items table 506 may include multiple records or entries respectively containing item information 602.

FIG. 6C is a block diagram illustrating item information 602, according to an embodiment. The item information 602 may include an item title 603 (e.g., DUAL-CORE PROCESSOR), an item description (not shown), an item image (not shown), an item price (not shown), item attributes 106 (e.g., SOCKET 775, POWER 65W, etc.) and other information. In another embodiment, the item attributes 106 for an item may be stored in the attributes table 507, and linked to the appropriate item in the items table 506, both shown on FIG. 5.

### Methods of Operation

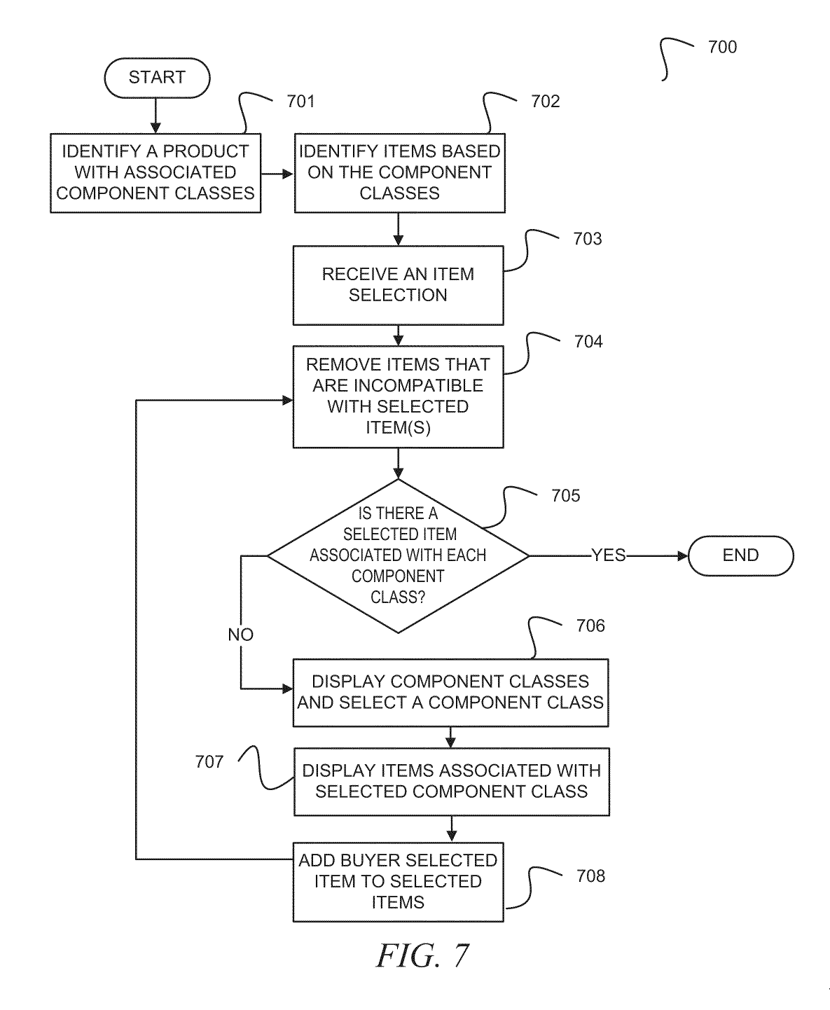

FIG. 7 is a flowchart illustrating a method 700, according to an embodiment. As an overview, the method 700 assists a customer in selecting compatible components of a product.

At 701, the product identification module 302 of FIG. 3 may identify a product including constituent component classes. In one embodiment, the product identification module 302 may identify the product responsive to the buyer 101 selecting the product. In another embodiment, the product identification module 302 may identify the product responsive to the buyer 101 selecting one or more items that the product identification module 302 identifies as associated with component classes of the product. For example, if the buyer 101 selected an item in the form of a computer processor, then the product identification module 302 may process the selection to identify a product in the form of a desktop computer system that includes a component class with which the selected computer processor is associated.

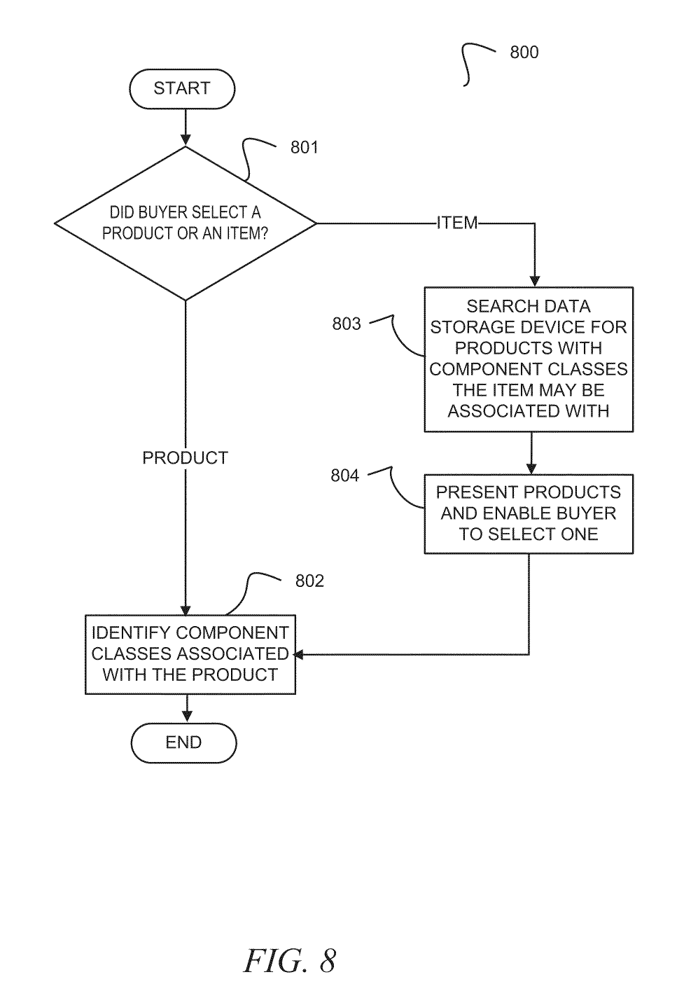

Referring to FIG. 8, FIG. 8 is a flowchart illustrating a method 800, according to an embodiment, to identify a product with associate component classes.

At 801, the product identification module 302 may determine whether the buyer 101 selected a product or an item. In one embodiment, the selection of a product may involve a user interface enabling the buyer 101 to view and select from various products.

At 802, the product identification module 302 may identify the component classes of the product and the method 800 ends. In one embodiment, the product component class table 508, shown on FIG. 5, may provide the component classes of the product.

At 803, the product identification module 302 may search a data storage device to identify one or more products with component classes with which the item may be associated. In one embodiment, the one or more databases 213 may be the data storage device and the database servers 212 may assist in searching the one or more databases 213, both shown on FIG. 2. In another embodiment, the items table 506, attributes table 507, and product component class table 508, shown on FIG. 5, or any combination of these tables, may be used by the product identification module 302 to determine a product with associated component classes for which the item may associated. For example, if the selected item is a dual-core processor, the item attributes 106, shown on FIG. 6C, may identify it as a processor and the product information 105, shown on FIG. 6A, may include a “processor” component class associated with a desktop computer, thus identifying the desktop computer as the product. In another embodiment, the product identification module 302 may identify multiple products if the component classes of more than one product may be associated to the item. For example, a “headphones” component class may be associated with both a desktop computer and a home entertainment system and so items associated with the “headphones” component class may identify both products.

At 804, the product identification module 302 may enable the buyer 101 to select a product. In one embodiment, the product identification module 302 may present the buyer 101 with a user interface including a list of products that enables the buyer 101 to select one or more products. At operation 802, the product identification module 302 may determine component classes associated with the product and then the process ends.

Referring back to FIG. 7, at 702, the compatibility module 303 of FIG. 3 may search a data storage device for a plurality of items that are associated with the component classes of the product identified at 701. For example, if the product is a desktop computer system, the compatibility module 303 may identify items associated with component classes in the form of a case, a motherboard, RAM, storage devices, input devices, monitors, and other peripheral devices, the items being instances of the identified components. For example, CRT or LCD monitors from various brands in various sizes may be items associated with an archetypical “monitor” component class. In one embodiment, the items may be found in the items table 506 shown on FIG. 5.

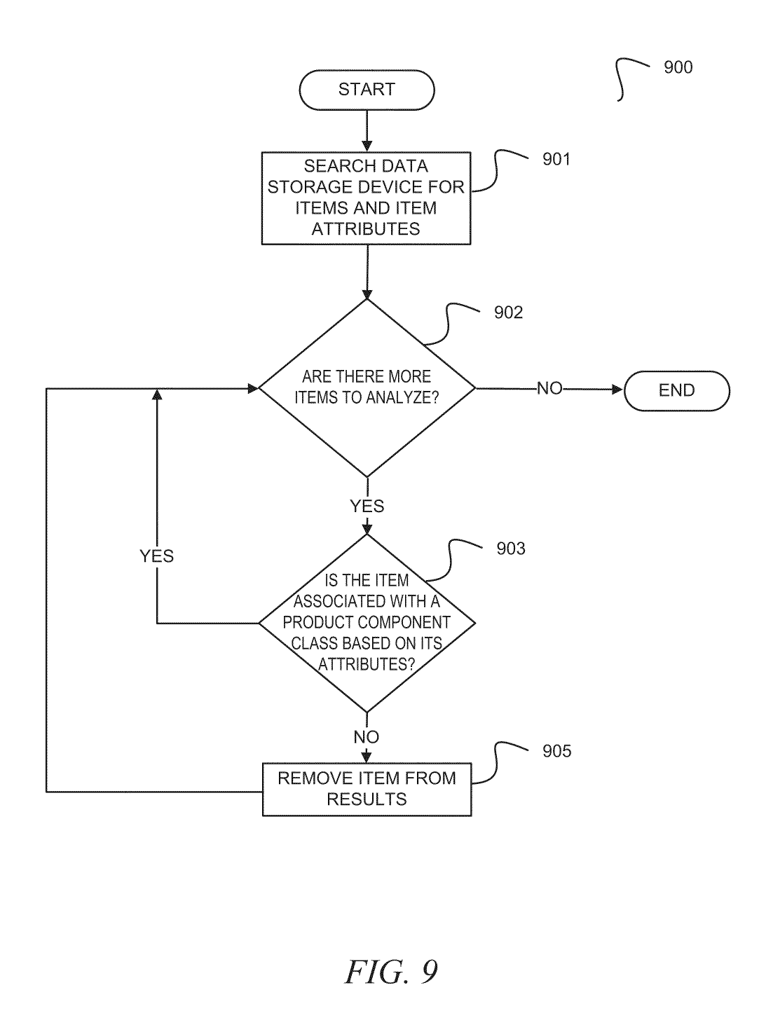

Referring to FIG. 9, FIG. 9 is a flowchart illustrating a method 900, according to an embodiment, to identify one or more items associated with each component class of a product.

At 901, the compatibility module 303 may search the data storage device to generate search results that include items. In one embodiment, the search results may include all of the items in the data storage device or a subset of the items, the subset of items being a result of different mechanisms that are utilized to filter the search results to reduce the number of items to be analyzed.

At 902, the compatibility module 303 may determine whether there are items in the search results to analyze. If there are no items to analyze, the method 900 ends.

At 903, the compatibility module 303 determines whether the item may be associated with a component class of the product based on the item attributes 106 associated with the item. For example, if the product is a desktop computer that includes a “processor” component class then item attributes 106 associated with the item may be analyzed by the compatibility module 303 to determine if the item is a processor.

At 905, the compatibility module 303 may remove the item from the search results.

It will be appreciated that method 900 may be performed differently than as described above. For example, the method 900 may be performed by using a database query to identify items with, for example, a processor attribute, when looking for desktop computer component classes. The actual implementation, however varied, simply analyzes the item attributes 106 to find items associated with component classes associated with the product.

Referring back to FIG. 7, at 703, an item selection may be received. In one embodiment, the selected item may be placed in a list of selected items or a list of items previously selected by the buyer 101.

At 704, the items from 702 may be analyzed by the compatibility module 303 of FIG. 3 to generate a list of one or more compatible items by removing items that are incompatible with items that the buyer 101 previously selected, i.e. items in the selected items list. For example, if the buyer 101 had previously selected a processor that fits into a “775 processor socket,” then motherboards without a “775 processor socket” are removed, i.e. the compatibility module 303 may not further consider them. In one embodiment, the removed items may be removed only in response to the current list of items that the buyer 101 had previously selected and may be re-introduced if the composition of the list changes so that they are no longer incompatible with the items in the list.

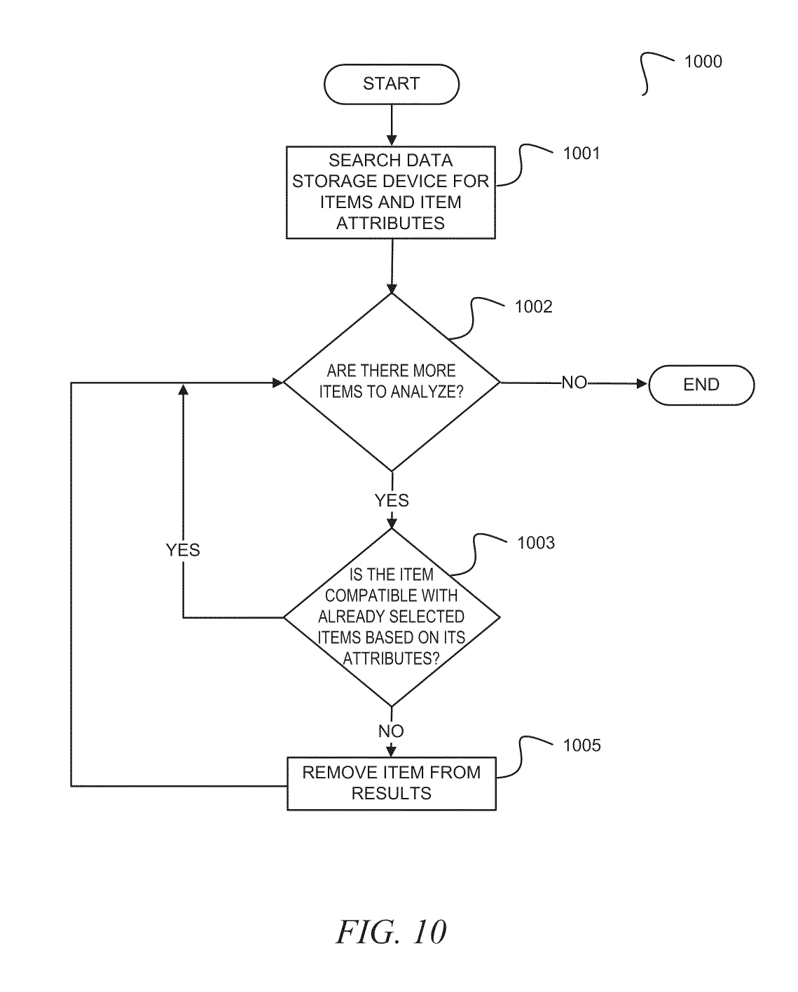

FIG. 10 is a flowchart illustrating a method 1000, according to an embodiment, to perform 704 of FIG. 7. At 1001, the compatibility module 303 of FIG. 3 may search the data storage device for items. In one embodiment, these items are a subset of the items identified by the product identification module 302 of FIG. 3 at 702 on FIG. 7. The items may be in memory already, or they may reside in the one or more databases 213 shown on FIG. 2. The items may be in the item table 506 of FIG. 5 and the item attributes 106 may be in the attributes table 507 as shown on FIG. 5.

At 1002, the compatibility module 303 may determine whether there are items from 1001 to analyze and if there are no more items to analyze, the method 1000 ends.

At 1003, the compatibility module 303 may determine whether the item is compatible with the items the buyer 101 previously selected. The compatibility module 303 may determine the item is compatible by analyzing the item attributes 106 associated with the item and the item attributes 106 associated with the items previously selected by the buyer 101. For example, if the product is a desktop computer and the buyer 101 has previously selected a mother board and processor, the item attributes 106 associated with the chosen item may be analyzed against the item attributes 106 associated with the motherboard and processor for compatibility.

At 1005, if at 1003 the compatibility module 303 determines that the item is not compatible with the items previously selected by the buyer 101 then the item is removed from the search results.

Referring back to FIG. 7, at 705, the flow module 304 of FIG. 3 may determine whether the buyer 101 has selected an item associated with each component class of the product. For example, if a home entertainment system included two component classes in the form of speakers and a receiver, the flow module 304 may verify that the buyer 101 had selected items associated with both speakers and a receiver. In one embodiment, the buyer 101 may request to terminate the flow by, for example, purchasing the selected items. In another embodiment, the buyer 101 may request that the flow be terminated and the un-purchased selected items may be stored in a personalized list for the buyer 101 for later reference by the buyer 101. If the buyer 101 has selected an item associated with each component class, or requests the flow to end, method 700 ends.

At 706, the flow module 304 may display the component classes to the buyer 101 via a user interface and receive a selection of a component class from the buyer 101. In one embodiment, the component classes may be displayed as a list of icons on the screen. Other embodiments may display the component classes in other ways to indicate to the buyer 101 that the component classes are associated with the product. In another embodiment, the current, or selected, component class may be automatically selected by the flow module 304 or it may be selected by the buyer 101. In another embodiment, the arrangement of the component classes may be known as a “flow.” The flow may indicate a progression through the component classes and may include ways to advance the progression.

At 707, the flow module 304 may display to the buyer 101 the remaining items that are associated with the selected component class. The buyer 101 may select one or more of these items to satisfy the selected component class. For example, if the product is a desktop computer, and the component class is “storage,” the buyer 101 may choose more than one hard disk drive if it is compatible with other item selections.

At 708, the flow module 304 may add the buyer 101 selected item(s) from 707 to the list of items previously selected by the buyer 101.

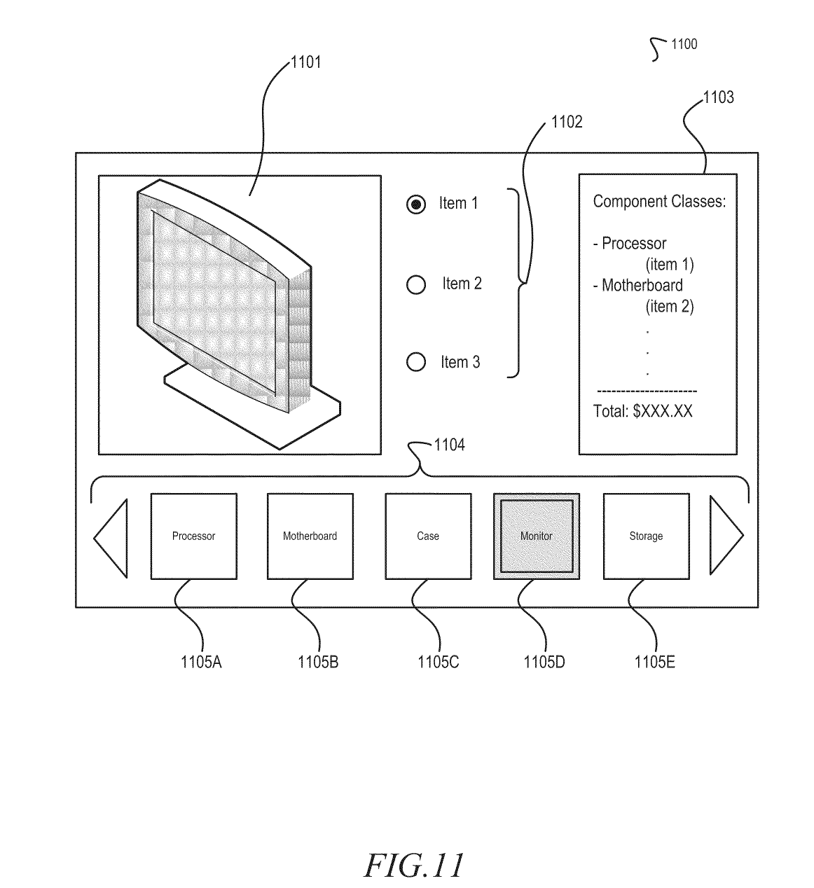

FIG. 11 is a diagram of a user interface 1100, according to an embodiment. In one embodiment, the user interface may be provided by the flow module 304 of FIG. 3. The user interface 1100 includes an item display 1101, a list of items 1102, a list of previously selected items 1103, and a flow user interface element 1104 that includes the component classes 1105A-E associated with the product. The list of items 1102 are associated with the currently selected “Monitor” component class 1105D. The item display 1101 displays the item that is currently selected from the list of items 1102. The example demonstrated in FIG. 11 is that of a desktop computer product with, at least, the component classes of “Processor” 1105A, “Motherboard” 1105B, “Case” 1105C, “Monitor” 1105D, and “Storage” 1105E. The buyer 101 has already selected an item for the “Processor” 1105A and the “Motherboard” 1105B component classes, as shown in the list of previously selected items 1103. The arrows in the flow user interface element 1104 enable the buyer 101 to navigate to possibly more component classes. The list of items 1102 may change as more items are selected because the compatibility of the unselected items displayed may be dynamically evaluated each time a new item is selected and moved to the list of previously selected items 1103. In various embodiments, the elements in the user interface 1100 may include additional features such as on-line help.

It will be understood that various user interfaces may be employed to convey the component classes and associated items to the buyer 101 and to guide the buyer 101 in the purchase of the product. For example, the user interface 1100 may order the component classes and enable the buyer 101 to select an item associated with the first component class, only moving to the next component class when an item has been selected.

Assisting buyers 101 in the purchase of items to complete a product may help to mitigate buyer 101 burdens in identifying the component classes and ensuring that the selected items associated with those component classes are compatible. Dynamically evaluating item compatibility as the buyer 101 selects items may help to mitigate the problems associated with static compatibility lists, including obsolescence and cost, and may allow a dynamic inventory to be fully utilized during the process. Decreasing buyer 101 burden while fully utilizing the present inventory may increase the likelihood that buyers will purchase additional items, thus increasing revenues.

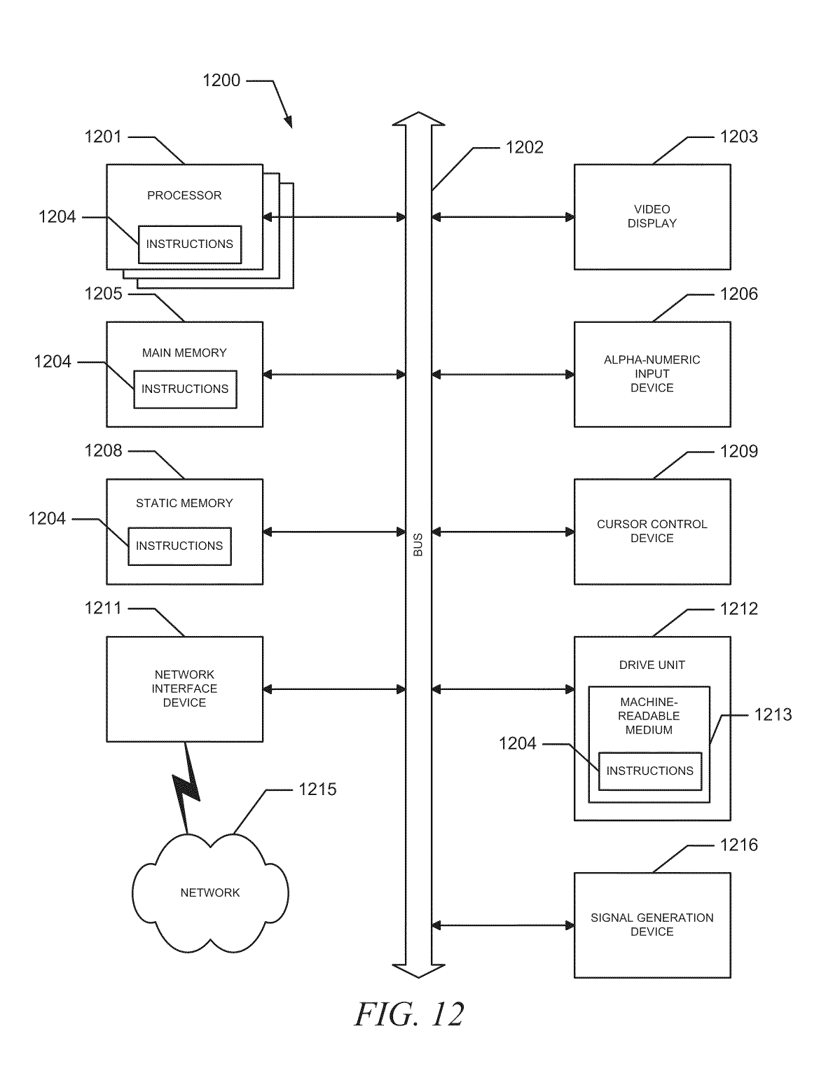

FIG. 12 shows a diagrammatic representation of a machine in the example form of a computer system 1200 within which a set of instructions may be executed for causing the machine to perform any one or more of the methodologies discussed herein. In alternative embodiments, the machine operates as a standalone device or may be connected (e.g., networked) to other machines. In a networked deployment, the machine may operate in the capacity of a server or a client machine in client-server network environment, or as a peer machine in a peer-to-peer (or distributed) network environment. The machine may be a server computer, a client computer, a personal computer (PC), a tablet PC, a set-top box (STB), a PDA, a cellular telephone, a web appliance, a network router, switch or bridge, or any machine capable of executing a set of instructions (sequential or otherwise) that specify actions to be taken by that machine. Further, while a single machine is illustrated, the term “machine” shall also be taken to include any collection of machines that individually or jointly execute a set (or multiple sets) of instructions to perform any one or more of the methodologies discussed herein.

The example computer system 1200 includes one or more processors 1201 (e.g., a central processing unit (CPU), a graphics processing unit (GPU), or both), a main memory 1205 and a static memory 1208, which communicate with each other via a bus 1202. The computer system 1200 may further include a video display unit 1203 (e.g. a liquid crystal display (LCD) or a cathode ray tube (CRT)). The computer system 1200 also includes an alpha-numeric input device 1206 (e.g., a keyboard), a cursor control device 1209 (e.g., a mouse), a disk drive unit 1212, a signal generation device 1216 (e.g., a speaker) and a network interface device 1211.

The disk drive unit 1212 includes a machine-readable medium 1213 on which is stored one or more sets of instructions (e.g., software) 1204 embodying any one or more of the methodologies or functions described herein. The instructions 1204 may also reside, completely or at least partially, within the main memory 1205, the static memory 1208, and/or within the processor 1201 during execution thereof by the computer system 1200. The main memory 1205 and the processor 1201 also may constitute machine-readable media. The instructions 1204 may further be transmitted or received over a network 1215 via the network interface device 1211.

Software applications that may include the apparatus and systems of various embodiments broadly include a variety of electronic and computer systems. Some embodiments implement functions in two or more specific interconnected hardware modules or devices with related control and data signals communicated between and through the modules, or as portions of an application-specific integrated circuit. Thus, the example computer system 1200 is applicable to software, firmware, and hardware implementations. In example embodiments, a computer system (e.g., a standalone, client or server computer system) configured by an application may constitute a “module” that is configured and operates to perform certain operations as described herein. In other embodiments, the “module” may be implemented mechanically or electronically. For example, a module may comprise dedicated circuitry or logic that is permanently configured (e.g., within a special-purpose processor) to perform certain operations. A module may also comprise programmable logic or circuitry (e.g., as encompassed within a general-purpose processor or other programmable processor) that is temporarily configured by software to perform certain operations. It will be appreciated that the decision to implement a module mechanically, in the dedicated and permanently configured circuitry, or in temporarily configured circuitry (e.g. configured by software) may be driven by cost and time considerations. Accordingly, the term “module” should be understood to encompass a tangible entity, be that an entity that is physically constructed, permanently configured (e.g., hardwired) or temporarily configured (e.g., programmed) to operate in a certain manner and/or to perform certain operations described herein.

While the machine-readable medium 1213 is shown in an example embodiment to be a single medium, the term “machine-readable medium” should be taken to include a single medium or multiple media (e.g., a centralized or distributed database, and/or associated caches and servers) that store the one or more sets of instructions. The term “machine-readable medium” shall also be taken to include any medium that is capable of storing, encoding or carrying a set of instructions for execution by the machine and that cause the machine to perform any one or more of the methodologies of the present description. The term “machine-readable medium” shall accordingly be taken to include, but not be limited to, solid-state memories, optical media and magnetic media. As noted, the software may be transmitted over a network using a transmission medium. The term “transmission medium” shall be taken to include any medium that is capable of storing, encoding or carrying instructions for transmission to and execution by the machine, and includes digital or analogue communications signal or other intangible medium to facilitate transmission and communication of such software.

The illustrations of embodiments described herein are intended to provide a general understanding of the structure of various embodiments, and they are not intended to serve as a complete description of all the elements and features of apparatus and systems that might make use of the structures described herein. Many other embodiments will be apparent to those of ordinary skill in the art upon reviewing the above description. Other embodiments may be utilized and from there derived, such that structural and logical substitutions and changes may be made without departing from the scope of this disclosure. The figures provided herein are merely representational and may not be drawn to scale. Certain proportions thereof may be exaggerated, while others may be minimized. Accordingly, the specification and drawings are to be regarded in an illustrative rather than a restrictive sense. The Abstract is provided to comply with 37 C.F.R. §1.72(b), requiring an abstract that will allow the reader to quickly ascertain the nature of the technical disclosure. It is submitted with the understanding that it will not be used to interpret or limit the scope or meaning of the claims.

Thus, a system and method to assist customers in selecting compatible components of a product are disclosed. While the present disclosure has been described in terms of several example embodiments, those of ordinary skill in the art will recognize that the present disclosure is not limited to the embodiments described, but may be practiced with modification and alteration within the spirit and scope of the appended claims. The description herein is thus to be regarded as illustrative instead of limiting.

What is claimed is:

1. A system comprising:
a data processor;
a data storage device coupled to the data processor;
a product identification module for execution by the data processor to identify a product associated with a plurality of component classes;
a compatibility module for execution by the data processor configured to:
search the data storage device based on the plurality of component classes to automatically identify a plurality of items offered for sale on a network-based marketplace, the plurality of items including at least one item that is incompatible with another item in the plurality of items;
receive a selection of a first item; and
remove incompatible items from the plurality of items to generate a list of one or more compatible items, the removal responsive to a determination whether the plurality of items are compatible with the first item; and
a flow module for execution by the data processor to communicate a user interface including the list of one or more compatible items.

2. The system of claim 1, wherein the product identification module is configured to identify the product in response to the receipt of the selection of the first item.

3. The system of claim 2, wherein the production identification module is configured to communicate a second user interface including one or more potential products associated with the plurality of component classes corresponding to the first item.

4. The system of claim 1, wherein the product identification module is configured to receive a selection of the product.

5. The system of claim 1, wherein the compatibility module is configured to add the first item to a selected items list and wherein the compatibility module is further configured to determine whether the plurality of items are compatible based on the selected items list.

6. The system of claim 5, wherein the flow module is further configured to:
display the plurality of component classes in a flow;
display one or more compatible items from the list of one or more compatible items corresponding to a selected component class, the selected component class being one of the plurality of component classes in the flow;
add a selected item from the one or more compatible items to the selected items list; and
advance the flow until the selected items list includes an item corresponding to each of the plurality of component classes or a flow termination request is received.

7. The system of claim 6, wherein the compatibility module is further configured to:
re-determine whether the plurality of items are compatible based on the selected items list in response to the addition of the selected item;
remove incompatible items from the plurality of items to regenerate the list of one or more compatible items; and
wherein the flow module is further configured to:
change the selected component class to a next component class in the flow; and
display the one or more compatible items from the list of one or more compatible items corresponding to the selected component class.

8. The system of claim 6, wherein the flow module is further configured to receive a selection of a component class, the component class becoming the selected component class and the component class having not already been selected.

9. The system of claim 1, wherein the compatibility module is configured to analyze item attributes.

10. The system of claim 1, wherein the compatibility module is to determine whether the plurality of items are compatible with the first item without using a predefined list of compatible items.

11. The system of claim 1, wherein the first item is an item that a buyer already owns.

12. A method comprising:
identifying a product associated with a plurality of component classes, the identifying using a data processor;
searching a data storage device based on the plurality of component classes to automatically identify a plurality of items being offered for sale on a network-based marketplace, the plurality of items including at least one item that is incompatible with another item in the plurality of items;
receiving a selection of a first item;
removing incompatible items from the plurality of items to generate a list of one or more compatible items, the removing responsive to determining whether the plurality of items are compatible with the first item; and
communicating a user interface including the list of one or more compatible items.

13. The method of claim 12, where the identifying the product is responsive to the receiving the selection of the first item.

14. The method of claim 13, wherein the identifying the product includes communicating one or more potential products associated with one or more component classes corresponding to the first item.

15. The method of claim 12, wherein the identifying the product includes receiving a selection of the product.

16. The method of claim 12, wherein the receiving the selection of the first item includes adding the first item to a selected items list and wherein the determining includes determining whether the plurality of items are compatible based on the selected items list.

17. The method of claim 16, wherein the communicating the user interface includes:
displaying the plurality of component classes in a flow;
displaying one or more compatible items from the list of one or more compatible items corresponding to a selected component class, the selected component class being one of the plurality of component classes in a flow;
adding a selected item from the one or more compatible items to the selected items list; and
advancing the flow until the selected items list includes an item corresponding to each of the plurality of component classes or a flow termination request is received.

18. The method of claim 17, wherein the advancing the flow includes:
re-determining whether the plurality of items are compatible based on the selected items list responsive to the adding the selected item;
removing incompatible items from the plurality of items to regenerate the list of one or more compatible items;
changing the selected component class to a next component class in the flow; and
displaying the one or more compatible items from the list of one or more compatible items corresponding to the selected component class.

19. The method of claim 17, wherein the advancing the flow includes receiving a selection of a component class, the component class becoming the selected component class and the component class having not already been selected.

20. The method of claim 12, wherein the determining includes analyzing item attributes.

21. The method of claim 12, wherein the determining does not include using a predefined list of compatible items.

22. The method of claim 12, wherein the first item is an item that a buyer already owns.

23. A machine-readable medium storing instructions that, when executed by at least one processor, cause the at least one processor to perform the following actions:
identifying a product associated with a plurality of component classes, the identifying using a data processor;
searching a data storage device based on the plurality of component classes to automatically identify a plurality of items being offered for sale on a network-based marketplace, the plurality of items including at least one item that is incompatible with another item in the plurality of items;
receiving a selection of a first item;
removing incompatible items from the plurality of items to generate a list of one or more compatible items, the removing responsive to determining whether the plurality of items are compatible with the first item; and
communicating a user interface including the list of one or more compatible items.
